(19) United States
(12) Patent Application Publication
(10) Pub. No.: US 2011/0006948 A1
(43) Pub. Date: Jan. 13, 2011

(54) ONBOARD ANTENNA SYSTEM FOR SATELLITE TRACKING WITH POLARIZATION CONTROL

(75) Inventors: Pierre Larregle, Munsbach (LU); Thomas Paillot, Toulouse (FR)

Correspondence Address: PEARNE & GORDON LLP, 1801 EAST 9TH STREET, SUITE 1200, CLEVELAND, OH, 44114-3108, US

(73) Assignee: AXESS EUROPE S.A., Luxembourg (LU)

(21) Appl. No.: 12/681,290

(22) PCT Filed: Oct. 2, 2008
(86) PCT No.: PCT/EP2008/063258

§ 371 Date: Sep. 21, 2010

(30) Foreign Application Priority Data
Oct. 4, 2007 (FR) 0758068

(51) Int. Cl. H01Q 21/24

(52) U.S. Cl. 342/361

(57) ABSTRACT

The present invention concerns an antenna system (100) intended to be embarked on an aircraft, comprising a phase-control array antenna (110) made up of a plurality of polarization-controlled elementary antennas (120), connected to at least one beamformer (151, 152), comprising:
a calculator (160) adapted to calculate phase offset values (φ_{V}, φ_{H}) and attenuation coefficients (α_{V}, α_{H}) from position and attitude information of the aircraft, coordinates of a telecommunications satellite and polarization characteristics of a transponder of said satellite;
a polarization control means (130) using said phase offset values and the attenuation coefficients to control the polarization of said elementary antennas.

### TECHNICAL FIELD

The present invention generally concerns onboard antenna systems, and more particularly array antenna systems with phase control for satellite telecommunications.

### BACKGROUND OF THE INVENTION

Communications between a civil or military aircraft and the ground generally go through satellite channels. Known in particular is the SATCOM telecommunications system implementing a constellation of geostationary satellites and offering worldwide coverage. Unlike a ground antenna, which can be fixedly pointed toward a geostationary satellite, an antenna embarked on an aircraft must track the satellite during flight and ensure continuous aiming of the beam toward the transponder used for communication. Several types of onboard antenna systems have been considered in the prior art to enable this tracking. It is known in particular from document U.S. Pat. No. 6,483,458 to use a motorized antenna, able to be oriented in azimuth and elevation, implementing conical scanning, also called “sequential lobing”, to continuously aim the opening of the antenna toward the transponder. It is also known, in particular from documents U.S. Pat. No. 6,650,291 and WO-A-92/21162, to use a phased array antenna for electronic aiming. The orientation of the beam in the desired direction is traditionally obtained by applying a given phase offset to the signals to be emitted by or received from each elementary antenna of the array. A first advantage of such an antenna is that it permits very rapid aiming of the beam, without mechanical inertia. A second advantage of such an antenna is that it can be realized as a conformal antenna, i.e. a flat antenna with a small thickness and which adapts to the curvature of the fuselage.

Most satellites emit and receive signals according to two orthogonal polarizations, in some cases at strictly identical frequencies. Only the polarization then makes it possible to separate the communication channels of the different transponders. For example, a first transponder may emit/receive according to a vertical polarization, i.e. with an electric field orthogonal to the ground surface, and a second neighboring transponder may emit/receive according to a horizontal polarization, i.e. with an electric field parallel to the ground surface, which makes it possible to transmit a second signal. In certain cases, the geostationary satellites emit and receive signals according to a right or left circular polarization.

Just like it is necessary to ensure the dynamic aiming of the beam toward the satellite, it is essential to maintain, during flight, the polarization of the transmitted signal or the polarization according to which the signal is received. Indeed, during flight, the polarization can depend on the position and the bank and heading angles of the aircraft. In particular, for satellites with a large coverage zone, the orientation of the polarization during the movement of the aircraft can vary within that zone.

The onboard antenna system described in application WO-A-92/21162 enables control of the polarization of the beam. To do this, it uses a phase control array, comprising elementary antennas with vertical and horizontal polarization. A closed-loop control controls the phase offset between two elementary antennas so as to keep the polarization of the signal constant.

The antenna system described above operates correctly when the closed-loop control is connected. However, in the satellite search phase, i.e. during the initial aiming, or during a handoff, it is delicate to obtain a transmission or receiving beam having the right polarization straightaway. Given that transponders of neighboring satellites or even transponders of a same satellite can use identical receiving frequencies with distinct polarizations, an incorrect polarization of the transmission beam during the satellite aiming phase can lead to crosstalk at said transponder(s). Similarly, incorrect polarization of the receiving beam during the aiming of the latter toward the satellite may lead to crosstalk at the receiver onboard the aircraft.

A first aim of the present invention is therefore to enable rapid and precise aiming of the transmission/receiving beam with good initial polarization during a seeking phase or handoff.

Moreover, with the increase of air traffic, the occupation rate of the transponders is increasing significantly. At a given moment, certain transponders of certain satellites can be saturated while others are only slightly occupied. An additional aim of the present invention is therefore to provide an onboard antenna system which is capable of adapting to a dynamic transponder assignment during flight.

### BRIEF DESCRIPTION OF THE INVENTION

The present invention is defined by an antenna system designed to be embarked on an aircraft, comprising a phase-control array antenna formed by a plurality of polarization-controlled elementary antennas, connected to at least one beamformer, the system comprising:
a calculator adapted to calculate phase offset values (φ_{y}, φ_{H}) and attenuation coefficients (α_{V}, α_{H}) from position and attitude information of the aircraft, coordinates of a telecommunication satellite and polarization characteristics of a transponder of said satellite;
a polarization control means using said phase offset values and said attenuation coefficients for controlling the polarization of said elementary antennas.

Advantageously, said system comprises a RF modulation/demodulation stage to modulate or demodulate baseband or intermediate frequency antenna signals, the demodulation signal being provided by a VCO controlled by said calculator.

The beamformer is adapted to form a transmitting or receiving beam using a plurality of phase offsets (ψₖ^{r}/aₖ^{r}, ψₖ^{e}/aₖ^{e}) provided by the calculator, said phase offsets advantageously being obtained by the latter from position and attitude information of the aircraft and coordinates from the satellite to be targeted.

The transmitting or receiving beamformer preferably operates on the signal to be emitted or the signals received in baseband and the phase offsets are obtained using a complex multiplication.

According to one embodiment, the system comprises a database which contains a list of the available geostationary satellites, with their respective coordinates, the polarization characteristics and the transmission/reception frequencies of the different transponders of said satellites.

The database is updated dynamically from a central database on the ground and contains a real-time assignment of the transponder(s) to be used for transmission and/or reception.

According to one alternative, the system comprises a first beamformer designed to form a beam in the direction of the transponder with which a communication is established, and a second beamformer designed to form a beam in the direction of a transponder with which a communication will be established later.

Advantageously, the array antenna of the system is of the conformal type.

### BRIEF DESCRIPTION OF THE DRAWINGS

Other characteristics and advantages of the invention will appear upon reading one preferred embodiment of the invention in reference to the attached figures, in which:

FIG. 1 diagrammatically illustrates an onboard antenna system according to one embodiment of the invention;

FIG. 2 illustrates a beam aiming method with polarization control according to one embodiment of the invention.

### DETAILED DESCRIPTION OF SPECIFIC EMBODIMENTS

The basic idea of the invention is to use the position and attitude information provided by the inertial unit or the navigation system of the aircraft and to calculate, according to this information and the coordinates of the satellite to be targeted, the phase offsets to be applied to the signals to be transmitted or received according to two orthogonal polarizations, so as to obtain the desired polarization of the beam during the initial aiming phase of the beam on the satellite.

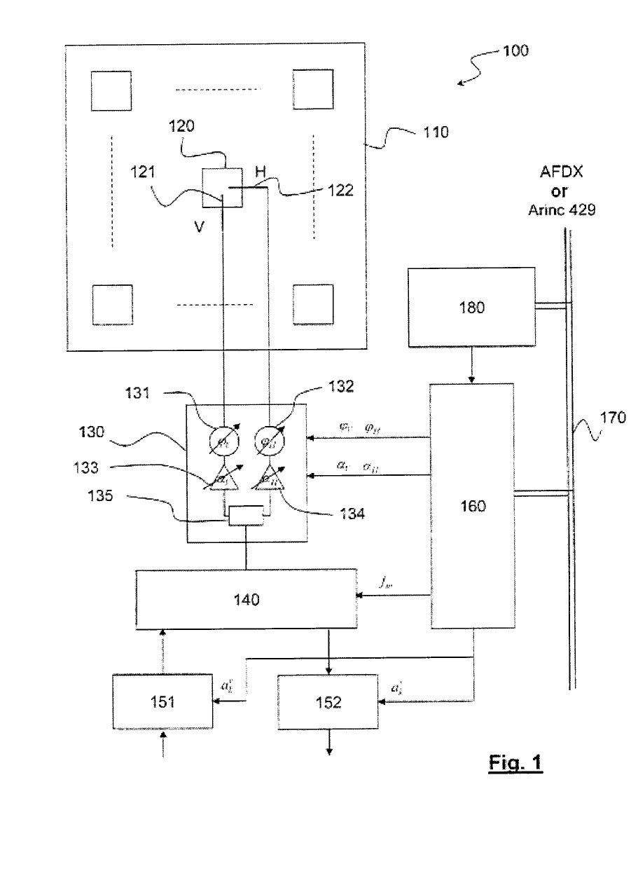

FIG. 1 illustrates an onboard antenna system according to one embodiment of the invention. This system 100 comprises a phase-control array antenna 110. Advantageously, this antenna can be conformal, i.e. have a flat profile, with a small height, fitting the shape of the fuselage of the aircraft. The array antenna 110 is made up of an arrangement of elementary antennas 120, the polarization of each elementary antenna being controllable. The elementary antenna 120 will, for example, be made using a patch antenna having two orthogonal feed probes 121, 122, in a manner known by one skilled in the art. Each elementary antenna 120 has its own polarization control 130 acting on the phase offset and, if necessary, the amplitude of each of the channels H and V. For example, if the antenna is of the aforementioned patch type, the polarization control means will include, for each of the orthogonal probes, i.e. for each of the channels H and V, a phase shifter 131, 132 and an amplitude controller 133, 134, for example an attenuator. One will denote φ_{H} and φ_{V} the phase offsets applied on the channels H and V, respectively. Likewise, one will note α_{H} and α_{V} the respective weight coefficients on these two channels. The signals from the channels H and V are combined in reception before being transmitted to a RF stage 140. Reciprocally, the antenna excitation signal, coming from the RF stage 140, is divided into two signals of channels V and H to feed the antenna. The combining/dividing operation is done by a power divider/combiner 135.

The RF transmission/reception stage comprises, for each elementary antenna, a duplexer (not shown) as well as a baseband demodulation module (not shown) or, if the case arises, a module for translation to an intermediate frequency. The baseband or intermediate band demodulation signal is provided by a numerically controlled VCO. The modulation/demodulation frequency fₘ is given by the calculator.

In transmission, the baseband signals are obtained by digital/analog conversion of the signals coming from the transmission beamformer 151. Reciprocally, in reception, the baseband signals destined for the different elementary antennas are subject to a digital/analog conversion before being transmitted to the reception beamformer 152. The beamformers 151 and 152 apply phase offsets on the base signals coming from or destined for the different antennas.

Advantageously, an amplitude weighting of these signals will be done so as to apodize the secondary lobes of the transmission or reception beam. The respective phase offsets of the different signals can be obtained by multiplying them by complex rotation coefficients, in a known manner. The amplitude weighting and the phase rotation of the complex digital samples are advantageously done using a single multiplication operation by a complex coefficient. More precisely, if s₁, . . . , s_{N} are the baseband digital signal samples coming from the N antennas, respectively, the reception beamformer performs the operation

$$r = {\sum }_{k = 1}^{N} {a}_{k}^{r} {s}_{k}$$

where r is the array antenna signal and the aₖ^{r} are said complex reception coefficients. Dually, for an transmission antenna s, the transmission beamformer generates a plurality N of phase offset and weighted signals a₁^{e}s, a₂^{e}s, . . . , a_{N}^{e}s where the aₖ^{e}, k=1, . . . , N are complex transmission coefficients. Of course, if the transmission beam aims in the same direction as the reception beam, one has aₖ^{e}=(aₖ^{r}) where .* designates the complex conjugation.

The calculator 160 provides on one hand the phase offsets φ_{H} and φ_{V}, and the coefficients α_{H} and α_{V}, for the polarization control 125 and, on the other hand, the phase offsets ψₖ^{e} and ψₖ^{r}, or more generally the complex coefficients aₖ^{e},aₖ^{r}, for the beamforming within 151 and 152.

The calculator determines the polarization phase offset(s) and the complex phase offset(s)/coefficients for aiming of the beam according, on one hand, to information relative to the satellite, stored in the database 180:
the coordinates of the searched satellite, i.e. its position on the geostationary orbit,
the characteristics of the polarization used by the transponder, for example vertical, horizontal, right or left circular,
   and, on the other hand, position and attitude information of the aircraft, for example its spatial coordinates and its heading, roll and bank angles, provided by the inertial unit or the navigation system of the aircraft, via a traditional avionic bus 170, of the Arinc 429 or AFDX (Avionics Full Duplex) type.

Knowing the position and attitude information of the aircraft in real-time, the calculator can determine, at any moment, the phase offsets ψₖ^{e}/ψₖ^{r} to be applied for aiming of the transmission/reception beam toward the satellite in question. From this same information as well as polarization characteristics of the transponder, the calculator 160 can determine the weighting coefficients α_{H} and α_{V} as well as the phase offsets φ_{H} and φ_{V} on the channels H and V of the polarization controllers. Thus, the polarization vector of the beam can be constantly oriented in the desired direction.

The database 180 contains the coordinates for the various available geostationary satellites. According to one particular embodiment, the database is updated in real-time in synchronization with a central database situated on the ground. The central database advantageously contains the assignment of the transponders to the different antennas of a given aircraft. This assignment can be dynamic and in particular vary according to the occupation rate of the transponders. Moreover, the assignment can depend on the Quality of Service (QoS) contractually defined with the client, in other words a client profile stored in the database. The database 180 consequently contains a real-time assignment of the transponder(s) to be used for the transmission and/or reception and consequently of the satellite(s) to target.

In order to enable a handoff without break in service, one can provide two distinct beamformers, a first beamformer performing aiming in the direction of the transponder being used and a second beamformer preparing aiming in the direction of the transponder which will be used. The two beamformings are done simultaneously such that a handoff amounts to a simple switch of the respective inputs (in transmission) or outputs (in reception) of the beamformers.

The database 180 lastly contains the characteristics of the transponders of the different available satellites, in particular the frequency, saturation power and polarization relative to each transponder.

Thus, the calculator 160 retrieves from the database or determines from information stored therein, the identity of the transponder/satellite assigned at the present moment. The characteristics related to the assigned transponder in particular make it possible to determine the modulation/demodulation frequency fₘ to control the VCO of the RF stage, the maximum transmission power Pₘₐₓ making it possible to avoid the saturation of the transponder, the orientation of the polarization vector.

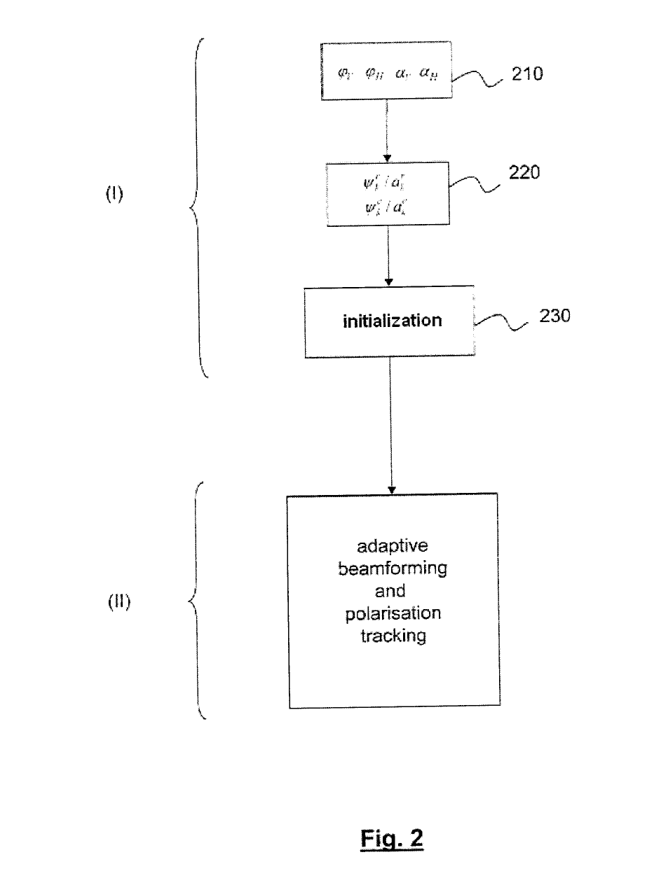

FIG. 2 illustrates an embodiment of the beam aiming method with polarization control, according to one embodiment of the invention.

The aiming of the beam, like the polarization control, comprises two phases: a first search phase, or initial aiming of the satellite/transponder, and a second tracking phase.

During the search phase (I), the calculator determines in 210 the phase offsets ensuring the pointing of the beam in the direction of the satellite and in 220 the phase offsets and weighting coefficients making it possible to align the direction of polarization on that of the transponder, taking the position and attitude of the aircraft into account. In 230, the beamformer(s) 151, 152 as well as the polarization control circuits 130 are initialized using these values. The good precision of the initial aiming combined with the good initial orientation of the polarization of the beam makes it possible to considerably reduce the crosstalk phenomena present in the state of the art.

During the tracking phase of the satellite (II), the control of the aiming and polarization of the beam can be done either in an open loop, as previously described, or in a closed loop, when the antenna system operates in reception mode. For example, the system can adaptively determine the phase offsets ψₖ^{r}, and more generally coefficients aₖ^{r}, using “monopulse” type techniques or conical scanning, known in the state of the art. The real-time adaptation of the phase offsets ψk^{r} or of the coefficients aₖ^{r} is done so as to maximize the signal received. Alternatively, the adaptation of the coefficients can be done traditionally from pilot sequences. One may in particular adapt the coefficients using the gradient algorithm, so as to minimize the error between received sequence and pilot sequence.

1. An antenna system (100) intended to be embarked on an aircraft, comprising a phase-control array antenna (110) made up of a plurality of polarization-controlled elementary antennas (120), connected to at least one beamformer (151, 152), characterized in that it comprises:
a calculator (160) adapted to calculate phase offset values (φ_{V}, φ_{H}) and attenuation coefficients (α_{V}, α_{H}) from position and attitude information of the aircraft, coordinates of a telecommunications satellite and polarization characteristics of a transponder of said satellite;
a polarization control means (130) using said phase offset values and the attenuation coefficients to control the polarization of said elementary antennas.

2. The antenna system according to claim 1, characterized in that it comprises a RF modulation/demodulation stage (140) to modulate or demodulate baseband or intermediate frequency antenna signals, the demodulation signal being provided by a VCO controlled by said calculator.

3. The antenna system according to claim 1, characterized in that the beamformer (151, 152) is adapted to form a transmission or reception beam using a plurality of phase offsets (ψₖ^{r}/aₖ^{r}, ψₖ^{e}/aₖ^{e}) provided by the calculator, said phase offsets being obtained by the latter from position and attitude information of the aircraft and coordinates of the satellite to be targeted.

4. The antenna system according to claim 3, characterized in that the transmission or reception beamformer operates on the signal to be emitted or the signals received in baseband, and that the phase offsets are obtained using a complex multiplication.

5. The antenna according to one of the preceding claims, characterized in that it comprises a database (180) containing a list of the available geostationary satellites with their respective coordinates, the polarization characteristics and the transmission/reception frequencies of the different transponders of said satellites.

6. The antenna system according to one of the preceding claims, characterized in that the database (180) is updated dynamically from a central database on the ground and that it contains a real-time assignment of the transponder(s) to be used for the transmission and/or reception.

7. The antenna system according to one of the preceding claims, characterized in that it comprises a first beamformer designed to form a beam in the direction of the transponder with which a communication is established, and a second beamformer designed to form a beam in the direction of a transponder with which a communication will be established later.

8. The antenna system according to one of the preceding claims, characterized in that the array antenna (110) is of the conformal type.
